(19) United States
(12) Patent Application Publication
(10) Pub. No.: US 2007/0058663 A1
(43) Pub. Date: Mar. 15, 2007

(54) Flexible collision detection serial bus transceiver apparatus and method

(76) Inventors: Phillip McGee, Owatonna, MN (US); Brad Moffett, Owatonna, MN (US); David Reul, Owatonna, MN (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/211,101

(22) Filed: Aug. 25, 2005

(51) Int. Cl. H04L 12/413

(52) U.S. Cl. 370/447

(57) ABSTRACT

A vehicle diagnostic tool includes an asynchronous serial communications device for communicating with an automobile using a digital communication system having a dominant/recessive bus. The device includes a transmitter configured to communicate over the dominant/recessive bus, a sensor capable of sensing the state of the dominant/recessive bus and a collision detection device configured to compare a desired bitstream transmitted by the transmitter and the state of the dominant/recessive bus, and generate an arbitration loss flag during the period when the desired bitstream is transmitted. Further, a method of communicating with an automobile using a digital communication system having a dominant/recessive bus is provided.

### FIELD OF THE INVENTION

The present invention relates generally to an apparatus and method for diagnosing events in a vehicle. More particularly, the present invention relates to an apparatus and a method to communicate with a Chrysler Collision Detection bus.

### BACKGROUND OF THE INVENTION

Vehicle repair stations generally diagnose and repair a variety of problems that may occur in motor vehicles, such as automobiles. Often, a service technician may diagnose a simple, complex, or even repetitive problem occurring in a vehicle using a variety of portable diagnostic equipment, or such problems can be replicated and addressed using more comprehensive diagnostic and/or repair equipment.

One common method to repair automobiles includes the use of diagnostic equipment to gather and subsequently analyze vehicle data in an attempt to pinpoint particular occurrences and/or potential problems in vehicles. This may be done, for example by coupling diagnostic equipment to an onboard computer of a vehicle to collect the data.

Some conventional diagnostic tools use an integrated chip (IC) to communicate with onboard vehicle computers. However, such ICs may not have the flexibility to be readily modified. To modify the diagnostic tool to accommodate newer versions of onboard computers, a wholly different IC may have to be redesigned and mounted within the tool. In addition, a traditional diagnostic tool communicating with an onboard computer may be susceptible to data corruption that results from collisions in the data being transmitted or received. A collision occurs when two or more devices send a signal simultaneously. This results in corruption of the data. Mechanisms exist that either attempt to avoid collisions or detect and correct collisions.

Accordingly, it is desirable to provide a means to communicate with a Chrysler Collision Detection bus (CCD) that is fast, easy and cost effective to properly diagnose and service Chrysler vehicles. In addition, it is desirable that the means of communication be readily configurable with new developments in the CCD. Also, it is desirable to provide a more efficient manner of preventing data corruption that occurs due to collisions.

### SUMMARY OF THE INVENTION

The foregoing needs are met, to a great extent, by the present invention, wherein in one aspect an apparatus is provided that in some embodiments communicates with a Chrysler Collision Detection bus in a fast, easy and cost effective manner to properly diagnose and service Chrysler vehicles. In addition, the means of communication may be readily configurable with new developments in the CCD bus. Also, a more efficient manner of preventing data corruption that occurs due to collisions is provided.

In accordance with one embodiment of the present invention, an asynchronous serial communications device for communicating with an automobile using a digital communication system having a dominant/recessive bus is provided. The device includes a transmitter configured to communicate over the dominant/recessive bus, a sensor capable of sensing the state of the dominant/recessive bus and a collision detection device configured to compare a desired bitstream transmitted by the transmitter and the state of the dominant/recessive bus, and generate an arbitration loss flag during the period when the desired bitstream is transmitted.

In accordance with another embodiment of the present invention, an asynchronous serial communications system for communicating with an automobile using a digital communication system having a dominant/recessive bus is provided. The device includes a transmitting means for communicating over a dominant/recessive bus, a sensing means for sensing the state of the dominant/recessive bus and a detection means for detecting collisions based on a desired bitstream transmitted by the transmitting means and the state of the dominant/recessive bus, and generating an arbitration loss flag any time during the period when the desired bitstream is transmitted.

In accordance with still another embodiment of the present invention, a method of communicating with an automobile using a digital communication system having a dominant/recessive bus is provided. The method includes transmitting a first stream of desired bits over the dominant/recessive bus, sensing the state of the dominant/recessive bus during transmission and performing a real-time collision detection process based on the stream of desired bits and the state of the dominant/recessive bus, and generating in real time an arbitration loss flag if the state of the dominant/recessive bus is inconsistent with the desired bitstream.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a view illustrating a vehicle with a CCD bus communicating with a diagnostic scan tool.

FIG. 2 is a diagnostic scan tool configured to communicate with a vehicle CCD bus.

FIG. 3 is a block diagram of the diagnostic scan tool in accordance with one embodiment of the method or process.

FIG. 4 is a timing diagram in accordance with an embodiment of the present invention.

FIG. 5 is flowchart illustrating steps that may be followed in accordance with an embodiment of the method or process.

### DETAILED DESCRIPTION

Onboard control computers have become ubiquitous in motor vehicles, as safety, economy, and emissions requirements have continued to escalate, and conventional designs for reciprocating engines, friction braking systems, collision safety apparatus, and traction control devices have proven unequal to the requirements set out in law and the implicit demands of competitors' achievements. Successive generations of onboard control computers have acquired increasing data sensing and retention capability as the electronic art has advanced. Present external diagnostic and display devices, known to those skilled in the art as scan tools, have been connected to the onboard control computers in order to gather vehicle data. Such scan tools may provide complex analysis of the data collected in order to diagnose problems in a vehicle.

Generally, a specialized integrated chip (IC) is required to communicate with all Chrysler vehicles that utilize a CCD bus. This chip is expensive and is fabricated to perform a single function. The CCD has been implemented on all Chrysler vehicles since 1992. Diagnostic analysis of these vehicles is impossible without the IC. Thus, once the production of the IC is discontinued, there will be no means of determining the problems associated with a Chrysler vehicle when it is brought into a vehicle repair station. A typical diagnostic tool capable of communicating with a CCD bus utilized this proprietary IC that combined the collision detection logic and the transceiver interface hardware together.

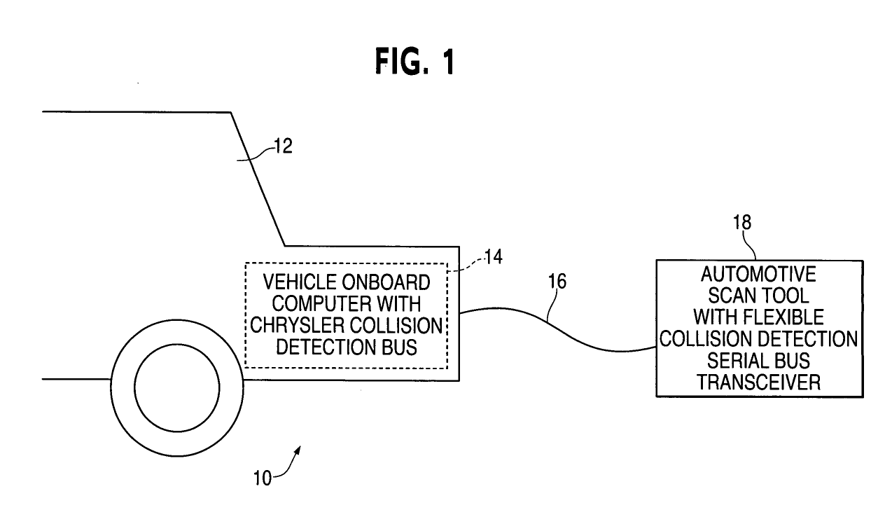

The invention will now be described with reference to the drawing figures, in which like reference numerals refer to like parts throughout. FIG. 1 is a view illustrating a vehicle 12 with a CCD bus 14 communicating 16 with a diagnostic scan tool 18. The manner of communicating 16 may be through any type of cable or the like. The manner of communicating 16 may also be wireless.

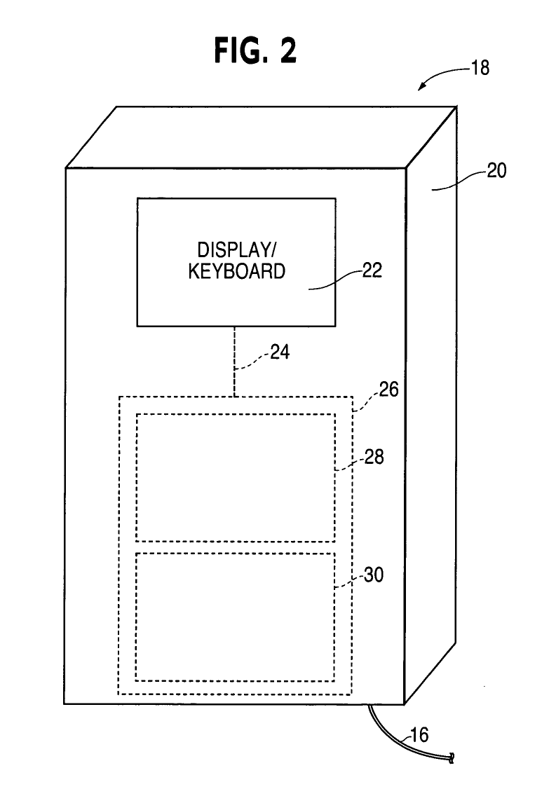

FIG. 2 is a diagnostic scan tool 18 configured to communicate with a vehicle CCD bus 14. The diagnostic scan tool 18 has a housing 20 that includes a display and/or keyboard 22. The display 22 may be any type of display such as an LCD display or the like. The keyboard 22 may be any type of inputting device such as buttons or the like.

The display/keyboard 22 are internally coupled 24 to a communication device 26. The communication device 26 may be a field programmable gate array (FPGA). The communication device 26 includes a transceiver interface hardware 28 and a SCI with enhanced collision detection logic 30. The CCD bus 14 communicates with the diagnostic scan tool 18 through the transceiver interface hardware 28 and the SCI with enhanced collision detection logic 30.

An embodiment in accordance with the present invention provides a field programmable gate array that will be used in the diagnostic tool to communicate with the CCD. This FPGA also has a more efficient means for idle detection and arbitration to prevent data collisions and data corruption than with conventional devices, thus increasing the efficiency and performance of the diagnostic tool.

Separating the functionalities of the transceiver interface hardware 28 and a SCI with enhanced collision detection logic 30 allows for the tool to be compatible to future technologies and developments in the CCD bus. The transceiver interface hardware 28 will readily incorporate future hardware platforms that require the ability to communicate with the CCD bus 14, whereas the FPGA software used for the collision detection logic 30, will also allow the tool to be used with future hardware platforms.

The ability to evolve and still maintain its ability to communicate with the CCD bus 14 is an important aspect as new car models are introduced and newer versions of onboard computers are also developed, adding additional features. The presently claimed invention replaces the integrated chip (IC) in a conventional diagnostic tool with an FPGA. As its name suggests, an FPGA is a type of logic chip that can be programmed by an engineer, unlike an IC that is programmed by the manufacturer. An FPGA is capable of supporting thousands of gates and is fully customizable by a user for any application. The presently claimed invention adds flexibility to the diagnostic tool in that the FPGA can be easily updated to accommodate modifications made to the CCD, without costly design time or remounting of the IC.

The FPGA is a type of logic chip that can be programmed and easily customized. The FPGA can be programmed to perform complex functions supporting thousands of gates. Although any FPGA can be used, an Altera EP1C3 may be utilized. The FPGA is a specially made digital semiconductor that can be used as a programmable logic device that emulates new electrical circuits as needed by the user. By incorporating the FPGA, the diagnostic tool can be updated with new circuits without the need of providing the actual new circuits on the boards or replacing the current boards on the diagnostic tool. The FPGA versatility can be used to provide new circuits for new communication protocols or other needs.

In a first embodiment, a conventional IC is replaced by a dynamic FPGA. The use of the FPGA allows an engineer or end user to enact changes without having to replace the processor. Changes to a mounted IC require remounting and reconfiguration of the design, which in turn requires more design hours. With the use of the FPGA, the designer is allowed to enact changes at any time without remounting the IC.

The FPGA is configured and arranged to operate as a conventional processor. In the preferred embodiment, the FPGA controls and processes a number of different functions. Additionally, data can be inputted into the FPGA through the input device, such as a keypad. The FPGA can transmit to and receive information from an output display, a serial port, such as a printer port, a second serial port, such as an infrared bar code reader, a module port that can accept various communication modules, or any other device that can communicate with the FPGA.

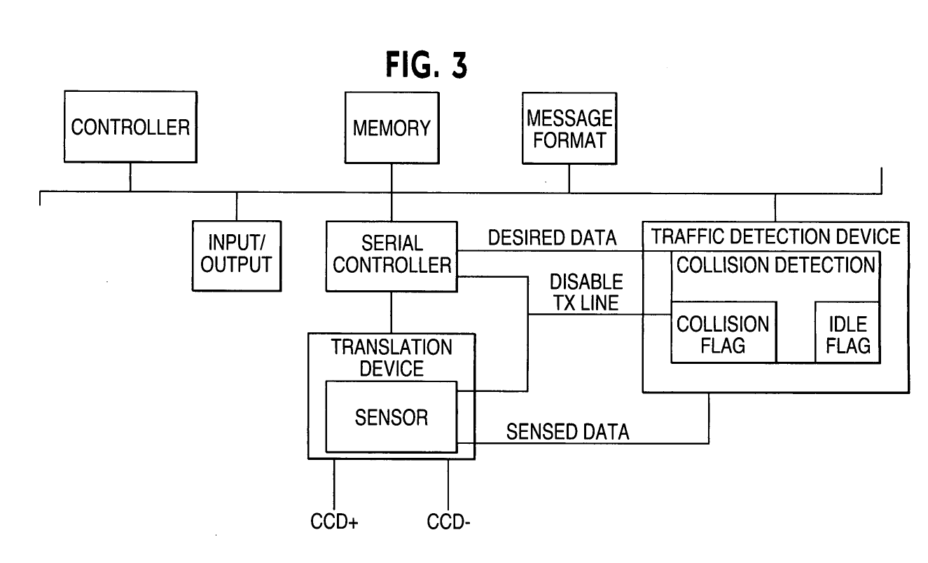

FIG. 3 is a block diagram of the diagnostic scan tool 18 in accordance with one embodiment of the method or process. As shown, the exemplary diagnostic scan tool device 18 according to the disclosed methods and systems is illustrated. The diagnostic scan tool 18 includes a controller 32, a memory 34, a message format device 36, a traffic detection device 38, a serial controller 54, a data translation device 56 and an input/output device 64. The traffic detection device 38 includes a collision detection device 40, that in turn includes an idle flag 42 and a collision flag 44. The traffic detection device 38 is coupled to the serial controller 54 via a desired data bus 46 and a disable line 48. The traffic detection device 38 is also coupled to the translation device 56 by the disable line 48 and a sensed data line 52.

The translation device 56 is coupled to a CCD− line 60 and a CCD+ line 62. The above components 32-64 are coupled together by control/data bus 65.

Although the exemplary modeling device 18 uses a bussed architecture, it should be appreciated that any other architecture may be used as is well known to those of ordinary skill in the art. It also should be appreciated that some of the above-listed components can take the form of software/firmware routines residing in memory 34 and capable of being executed by the controller 32. Further, it should be understood that the functions of any or all of components 32-65 can be accomplished using object-oriented software, thus increasing portability, software stability and a host of other advantages not available with non-object-oriented software. The controller may also take the form of being integrated within the FPGA so that a separate IC is not required.

In operation, data can be received by the input/output device 64 derived from memory 34 or derived otherwise by the controller 32. The data is then sent to the message format device 36 where the data is broken up into segments and altered to include a number of start and stop bits. Once the data is appropriately formatted, the formatted data is provided to the serial controller 54, which in turn provides a serial version of the formatted data to the translation device 56. The particular format used in the present embodiment is similar to that of a universal asynchronous receiver and transmitter, or UART. However, the particular format used can vary from embodiment to embodiment as may be required or found desirable.

While a UART format or similar format can be used in the disclosed methods and systems, it should be appreciated that the bitstreams produced by the translation device 56 will be transmitted on a bi-directional bus and subject to bus contention as will be explained below.

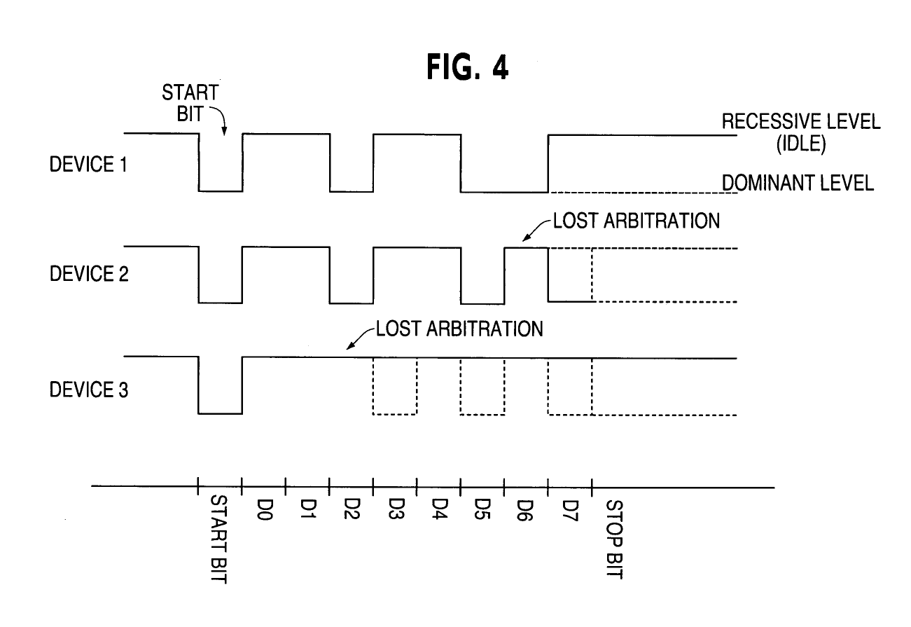

FIG. 4 illustrates the serialized, formatted data in a timing diagram in accordance with an embodiment of the present invention. In particular FIG. 4 the timing diagram illustrates three devices (including the system 18 of FIG. 3) attempting to communicate with a common CCD bus.

The CCD protocol uses a bi-directional pair of differential signals. The Rx and Tx signals share the same path. Additionally, the CCD bus may have more than one controller attached along with a diagnostic scan tool. As information can come from multiple sources, two or more controllers may begin to transmit their data concurrently. When there is no communication or nothing is transmitted, the CCD bus idles at a specified voltage level. When a CCD controller begins to transmit its data, the first bit of each data word corresponds to a low logic level. The low logic level drives the CCD bus to a different voltage level than when it was at idle. This driven voltage level is the dominant level. The idling voltage level is the recessive level. Dominant bits are in effect logic low or ‘0’ bits and recessive bits are logic high or ‘1’ bits.

When two or more CCD controllers transmit at the same time, the first one to transmit a dominant bit wins arbitration if the other controllers are transmitting a recessive bit. Arbitration is generally when a system determines which node or device can transmit at which time. The controllers that lost arbitration stop transmitting and allow the winning controller to transmit without corruption of its data.

To detect the occurrence of a collision, the previously used CCD IC had to compare the data byte just transmitted to the data byte it received. If the bytes were different, there was an indication of a collision and the scan tool lost arbitration of the bus. This is known in the art as the “read back and compare” method.

In contrast, the presently claimed methods and systems perform this collision detection function using a status flag that is used to generate an interrupt to the scan tool's central processing unit, or CPU. This flag and interrupt alert the driver software to the condition of lost arbitration faster than the previous “read back and compare” method.

When a collision is detected, the transmission is halted to prevent corruption of the data. Once another driver completes its transmission, the halted transmission is re-transmitted. Thus, the flag signals the recessive devices to wait until the dominant device has completed its transmission. Thus, the flag permits immediate detection of a collision and prevents data corruption. Also, there is no need for retransmitting data that was already sent. Therefore, this is a more efficient manner of preventing data corruption.

Returning to FIG. 4, device 3 loses arbitration at bit D2 when it attempts to transmit a “1” at the same time device 1 and device 2 transmits a dominate “0”. Accordingly, subsequent to bit D2, device 3 will stop transmitting to prevent any further corruption on the data bus. Later, device 2 loses arbitration at bit D6 as it attempts to transmit a “1” while device 1 transmits a dominant “0”. As before, device 2 will stop transmission. Incidentally should all of the devices 1-3 transmit the same bit-pattern at the same time, no collision will be detected and no data will be corrupted.

The previously used CCD IC derived its timing from a 1 MHz crystal or clock signal and performed the appropriate division to obtain the required timing. The CCD IC detected the idle condition and signaled the separate UART device of the occurrence. In contrast, the UART-like device of the disclosed methods and systems can use its ability to sense and use the externally generated idle signal. This allows for reduced FPGA pin count, reduced hardware implementation cost and greater flexibility in implementing the CCD physical layer.

Returning to FIG. 3, once the serial controller 54 receives a formatted word of data, the serial controller 54 can hold the data until it receives an indication from the traffic detection device 38 via the Disable TX line (IDLE FLAG 42) indicating that the CCD lines 62 and 64 are in an idle condition. Once the idle indication is received, the serial controller 54 can provide the appropriate stream of bits to the translation device 56 for output on the CCD Bus as well as provide the same information to the collision detection device 40 via the desired data line 46.

As the data stream is output on the CCD Bus, the sensor 58 can monitor the CCD Bus and output its sensed data to the collision detection 40 via the sensed data line 52. In turn, the collision detection device 40, receiving both the desired output data and the sensed (Actual) data on the CCD Bus, can determine whether a data collision has occurred, i.e., where the desired data is a “1” and the sensed data is a “0”.

Upon a collision, the collision flag 44 will activate, thus activating the Disable TX Line 48, and thus disabling one or both of the translation devices output drivers and the serial controller 54.

Next, the traffic detection device 38 can send a signal to the controller 32 indicating that a collision has occurred and output data corrupted. In turn, the controller 32 can manipulate the serial controller 54 into rebroadcasting the data stream at a later time.

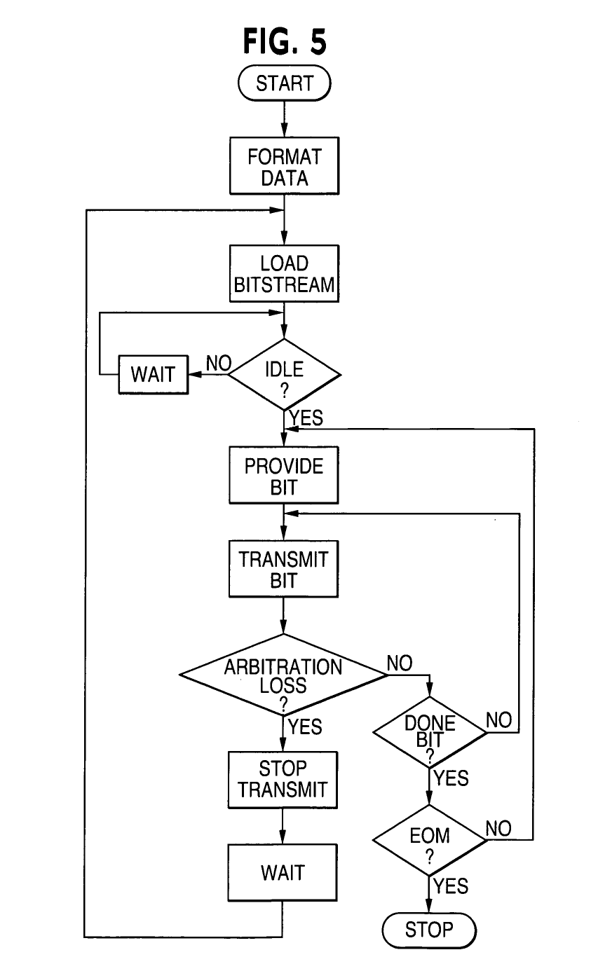

FIG. 5 is flowchart illustrating steps that may be followed in accordance with one embodiment of the method or process. The process starts in step 84 when data is formatted into a suitable bit stream. The data continues to step 86 where the bitstream is loaded 86. Next, in step 88, a determination is made as to whether the intended CCD bus is idle. If the system is idle, control continues to step 92; otherwise, control jumps to step 90 where a period of time passes and step 88 is repeated. In step 92, i.e., the CCD bus is idle and a first data bit is provided to a translation device bus driver whereafter it is transmitted on the CCD bus in step 94.

Next, in step 96, a determination is made as to whether an arbitration loss has occurred, i.e., the desired data to be transmitted does not match the actual data on the CCD bus. If arbitration is lost, control jumps to step 102; otherwise, control continues to step 98. In step 98, data transmission is stopped. Next, in step 100, a waiting period occurs. Control then jumps back to step 86 where the formatted data is reloaded for subsequent transmission.

In step 102, which assumes that there has been no arbitration loss, a determination is made as to whether the transmission of the first bit is complete. If transmission is not complete, control jumps back to step 94 where data transmission continues, otherwise, control continues to step 104.

In step 104, a determination is made as to whether and End of Message condition occurred, i.e., all bits in the bitstream have been transmitted. If all bits have been transmitted, control continues to step 106 where the process stops; otherwise, control jumps back to step 92 where the next bit in the bitstream is provided the CCD Bus.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An asynchronous serial communications device for communicating with an automobile using a digital communication system having a dominant/recessive bus, the device comprising:
a transmitter configured to communicate over the dominant/recessive bus;
a sensor capable of sensing the state of the dominant/recessive bus; and
a collision detection device configured to compare a desired bitstream transmitted by the transmitter and the state of the dominant/recessive bus, and generate an arbitration loss flag during the period when the desired bitstream is transmitted.

2. The device of claim 1, wherein the collision detection device is configured to generate the arbitration loss flag during the period when a data bit is transmitted.

3. The device of claim 1, wherein the collision detection device is configured to generate the arbitration loss flag when a dominant state on the dominant/recessive bus is sensed and when the transmitter is attempting to communicate a recessive state.

4. The device of claim 1, wherein the transmitter is configured to communicate with a bus having a bi-directional pair of differential signals.

5. The device of claim 4, wherein the device is configured to communicate with a Chrysler collision detection vehicle bus.

6. The device of claim 3, further comprising the collision detection device is configured to generate the arbitration loss flag during transmission of a data bit.

7. The device of claim 1, wherein activation of the arbitration loss flag will disable the communication device from further transmitting before transmission of a subsequent bit of the desired bitstream is transmitted.

8. The device of claim 1, wherein the collision detection device stops the desired bitstream when the arbitration loss flag is generated by disabling a driver disposed in the transmitter to an inactive output state or by resetting a serial controller providing the desired bitstream.

9. The device of claim 8, wherein the serial controller is a universal asynchronous receiver transmitter.

10. The device of claim 1, further comprising an idle detection device configured to detect when there is no transmission over the Chrysler collision detection bus for a proscribed minimum time.

11. An asynchronous serial communications system for communicating with an automobile using a digital communication system having a dominant/recessive bus, the device comprising:
a transmitting means for communicating over a dominant/recessive bus;
a sensing means for sensing the state of the dominant/recessive bus; and
a detection means for detecting collisions based on a desired bitstream transmitted by the transmitting means and the state of the dominant/recessive bus, and generating an arbitration loss flag any time during the period when the desired bitstream is transmitted.

12. The system of claim 11, wherein the detection means generates an arbitration loss flag when a dominant state on the dominant/recessive bus is sensed and when the transmitting means attempts to communicate a recessive state.

13. The device of claim 11, further comprising an idle detection means to detect when there is no transmission over the dominant/recessive bus for a proscribed minimum time.

14. The device of claim 11, wherein the system is configured to communicate with a Chrysler collision detection vehicle bus.

15. A method of communicating with an automobile using a digital communication system having a dominant/recessive bus, the method comprising:
transmitting a first stream of desired bits over the dominant/recessive bus;
sensing the state of the dominant/recessive bus during transmission; and
performing a real-time collision detection process based on the stream of desired bits and the state of the dominant/recessive bus, and generating in real time an arbitration loss flag if the state of the dominant/recessive bus is inconsistent with the desired bitstream.

16. The method of claim 15, further comprising disabling transmission of the desired bits over the dominant/recessive bus before the start of the transmission of a next bit of the desired bitstream upon activation of the arbitration loss flag.

17. The method of claim 16, wherein the step of disabling comprises disabling a driver disposed in the transmitter to an inactive output state or by resetting a serial controller providing the desired bitstream.

18. The method of claim 15, wherein the arbitration loss flag is generated during the period when a data bit is transmitted.

19. The method of claim 15, wherein the arbitration loss flag is generated when a dominant state on the dominant/recessive bus is sensed and when the transmitter is attempting to communicate a recessive state.

20. The method of claim 15, wherein the system is configured to communicate with a Chrysler collision detection vehicle bus.
